(19) United States
(12) Patent Application Publication
(10) Pub. No.: US 2023/0116106 A1
(43) Pub. Date: Apr. 13, 2023

(54) Systems and Methods for Asset Interchange

(71) Applicant: Capital One Services, LLC, McLean, VA (US)

(72) Inventors: Elizabeth Furlan, Plano, TX (US); Steven Dang, Plano, TX (US); Chih-Hsiang Chow, Coppell, TX (US)

(21) Appl. No.: 17/500,560

(22) Filed: Oct. 13, 2021

(51) Int. Cl. G06Q 30/08; G06F 16/901; G06F 16/9535; G06N 20/00

(52) U.S. Cl. CPC G06Q 30/08; G06F 16/9024; G06F 16/9535; G06N 20/00

(57) ABSTRACT

Systems and methods for asset interchange are disclosed. In one embodiment, a method includes receiving an indication that a user wants to exchange a first product, determining a plurality of second products different from the first product, identifying a plurality of second users that own at least one of the plurality of second products, generating a bipartite graph representing a plurality of different connections between the user and the plurality of second users, wherein each connection of the plurality of different connections represents an interchange of the first product with one or more of the plurality of second products, generating an interchange recommendation from the bipartite graph, transmitting the interchange recommendation to a first computing device and a second computing device, receiving an interchange approval message from the first computing device and the second computing device, generating interchange instructions, and transmitting the generated interchange instructions.

### TECHNICAL FIELD

Aspects described herein generally relate to data analytics and more specifically to analyzing data using graph databases.

### BACKGROUND

Large organizations typically generate vast amounts of data as part of running their business processes. Examples of generated data can include sales data of a large multinational organization, loan and deposits data for a commercial bank, customer spend data for a credit card firm, patient response data during a drug trial, etc. As an example, a sale transaction can include a large number of dimensions including, but not limited to, product, sales person, location, time of sale, customer, etc.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Systems and methods for asset interchanges in accordance with embodiments of the invention are disclosed. In one embodiment, a computer-implemented method includes receiving an indication that a user wants to exchange a first product owned by the user, determining, based on one or more properties of the first product, a plurality of second products different from the first product, identifying a plurality of second users that own at least one of the plurality of second products, generating a bipartite graph representing a plurality of different connections between the user and the plurality of second users, wherein each connection of the plurality of different connections represents an interchange of the first product with one or more of the plurality of second products, generating an interchange recommendation from the bipartite graph and based on the plurality of different connections, transmitting the interchange recommendation to a first computing device associated with the user and a second computing device associated with a second user associated with the second product of the plurality of second products identified in the interchange recommendation, receiving an interchange approval message from the first computing device and the second computing device, generating interchange instructions indicating the interchange recommendation, and transmitting the generated interchange instructions.

In yet another additional embodiment of the invention, generating the interchange recommendation includes providing, as input to a trained machine learning model, data corresponding to the bipartite graph, wherein the trained machine learning model has been trained based on a history of product interchanges, receiving, as output from the trained machine learning model, an indication of a selected connection, and generating the interchange recommendation based on the selected connection.

In still another additional embodiment of the invention, generating the interchange recommendation includes calculating, for each of the plurality of different connections, a confidence metric determined based on criteria selected from the group consisting of a geographical location of the user, a value of the first product, and a perceived interest of the user and selecting a connection in the plurality of different connections as the interchange recommendation based on the confidence metric.

In yet still another additional embodiment of the invention, the selected connection includes the connection with the highest confidence metric.

In yet another embodiment of the invention, the selected connection includes the connection that, when selected, maximizes a value of the remaining connections within the bipartite graph.

In still another embodiment of the invention, the selected connection includes a connection having a confidence metric exceeding a threshold value.

In yet still another embodiment of the invention, the computer-implemented method further includes removing the user and the second user indicated in the interchange recommendation from the bipartite graph.

In yet another additional embodiment of the invention, the indication that the user wants to exchange the first product includes a search query for at least one of the plurality of second products.

In still another additional embodiment of the invention, determining the plurality of second products includes determining an age of the first product and querying a product database for products newer than the first product.

In yet still another additional embodiment of the invention, the interchange instructions cause a third-party system to execute the interchange of the first product and the second product.

In yet another embodiment of the invention, the interchange instructions further cause the third-party system to obtain first location information for the user, obtain second location information for the second user associated with the second product identified in the interchange recommendation, calculate a distance between the first location information and the second location information, and provide an indication of the calculated distance to the user and the second user.

Still another embodiment of the invention includes an apparatus including one or more processors and memory storing instructions that, when executed by the one or more processors, cause the apparatus to receive an indication that a user wants to exchange a first product owned by the user, determine, based on one or more properties of the first product, a plurality of second products different from the first product, identify a plurality of second users that own at least one of the plurality of second products, generating a bipartite graph representing a plurality of different connections between the user and the plurality of second users, wherein each connection of the plurality of different connections represents an interchange of the first product with one or more of the plurality of second products, generate an interchange recommendation from the bipartite graph and based on the plurality of different connections, transmit the interchange recommendation to a first computing device associated with the user and a second computing device associated with a second user associated with the second product of the plurality of second products identified in the interchange recommendation, receive an interchange approval message from the first computing device and the second computing device, generate interchange instructions indicating the interchange recommendation, and transmit the generated interchange instructions.

In yet another embodiment of the invention, the interchange recommendation is generated by providing, as input to a trained machine learning model, data corresponding to the bipartite graph, wherein the trained machine learning model has been trained based on a history of product interchanges, receiving, as output from the trained machine learning model, an indication of a selected connection, and generating the interchange recommendation based on the selected connection.

In still another embodiment of the invention, the interchange recommendation is generated by calculating, for each of the plurality of different connections, a confidence metric determined based on criteria selected from the group consisting of a geographical location of the user, a value of the first product, and a perceived interest of the user and selecting a connection in the plurality of different connections as the interchange recommendation based on the confidence metric.

In yet still another embodiment of the invention, the selected connection is determined based on criteria selected from the group consisting of the connection with the highest confidence metric, the connection that, when selected, maximizes a value of the remaining connections within the bipartite graph, and a connection having a confidence metric exceeding a threshold value.

In yet another additional embodiment of the invention, the indication that the user wants to exchange the first product includes a search query for at least one of the plurality of second products.

In still another additional embodiment of the invention, the interchange instructions cause a third-party system to execute the interchange of the first product and the second product.

Yet another embodiment of the invention includes one or more non-transitory computer-readable media storing instructions that, when executed by one or more processors, cause a computing device to receive an indication that a user wants to exchange a first product owned by the user, determine, based on one or more properties of the first product, a plurality of second products different from the first product, identify a plurality of second users that own at least one of the plurality of second products, generating a bipartite graph representing a plurality of different connections between the user and the plurality of second users, wherein each connection of the plurality of different connections represents an interchange of the first product with one or more of the plurality of second products, generate an interchange recommendation from the bipartite graph and based on the plurality of different connections, transmit the interchange recommendation to a first computing device associated with the user and a second computing device associated with a second user associated with the second product of the plurality of second products identified in the interchange recommendation, receive an interchange approval message from the first computing device and the second computing device, generate interchange instructions indicating the interchange recommendation, and transmit the generated interchange instructions.

In yet another additional embodiment of the invention, the instructions, when executed by the one or more processors, cause the computing device to calculate, for each of the plurality of different connections, a confidence metric determined based on criteria selected from the group consisting of a geographical location of the user, a value of the first product, and a perceived interest of the user and select a connection in the plurality of different connections as the interchange recommendation based on the confidence metric.

In still another additional embodiment of the invention, the interchange instructions cause a third-party system to execute the interchange of the first product and the second product.

Other objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the claims.

### BRIEF DESCRIPTION OF THE DRAWINGS

The present disclosure is described by way of example and not limited in the accompanying figures in which like reference numerals indicate similar elements and in which:

FIG. 1 shows an example of an operating environment in which one or more aspects described herein may be implemented;

FIG. 2 shows an example computing device in accordance with one or more aspects described herein;

FIG. 3 shows an example graph database according to one or more aspects of the disclosure;

FIG. 4 shows a flow chart of a process for providing interchange instructions according to one or more aspects of the disclosure; and

FIG. 5 shows a flow chart of a process for generating interchange instructions according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure can be practiced. It is to be understood that other embodiments can be utilized and structural and functional modifications can be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

Systems and methods in accordance with embodiments of the invention can use a variety of graph databases to identify and facility asset interchanges. Assets can be owned by a first user that wishes to exchange or upgrade their assets. Users can be matched with a second user owning an asset for which the first user would be willing to exchange their asset. A graph database of first users and second users can be generated, with the users represented by nodes and edges in the graph database indicating potential interchanges of assets between a user in the first group and a user in the second group. Each of the edges may have an associated weight and interchange recommendations can be determined based on the edges. An interchange recommendation can indicate the first user and the second user and various interchange recommendations can be generated based on the edges in the graph database. The interchange recommendations can be provided to each user and, if both users accept, instructions can be generated to cause the asset interchange to be performed.

For example, auto customers may have purchased a car that and have trouble in making the payments. Consider two classes of customers, downgrade users which have newer, more expensive cars and who are behind (or in danger of being behind) on their payments, and upgrade users that have older car that they are willing to trade in on a newer vehicle. Each of the upgrade users can be matched with one or more of the downgrade users based on their respective vehicles, where each pairing of an upgrade user and a downgrade user can indicate that an exchange of the upgrade user's vehicle would meet the needs of the downgrade user (e.g. number of seats, fuel economy, payment amount, etc.) and the downgrade user's vehicle would meet the needs of the upgrade user (e.g. color, performance, number of seats, etc.). Pairings of upgrade users and downgrade users can be determined and, for a particular pairing, the potential vehicle exchange can be proposed to the upgrade user and the downgrade user. If both users accept, the system can generate instructions to cause one or more third-party systems to perform the desired exchange. For example, the instructions can cause the third-party systems to generate documentation to perform the vehicle exchange, arrange for transportation of the vehicles from the upgrade user and the downgrade user, and any other aspects of the exchange as needed.

### Operating Environments and Computing Devices

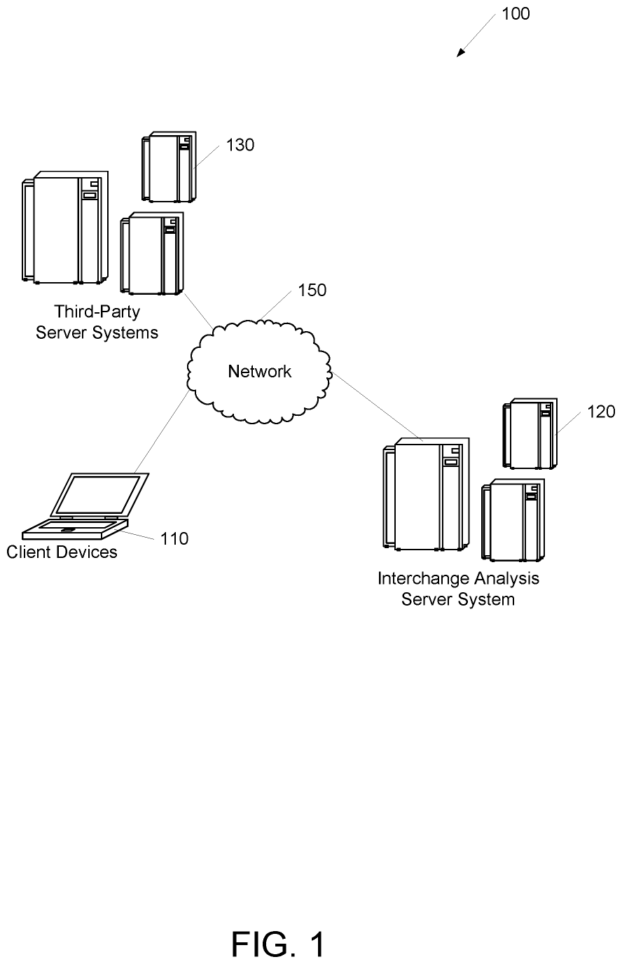

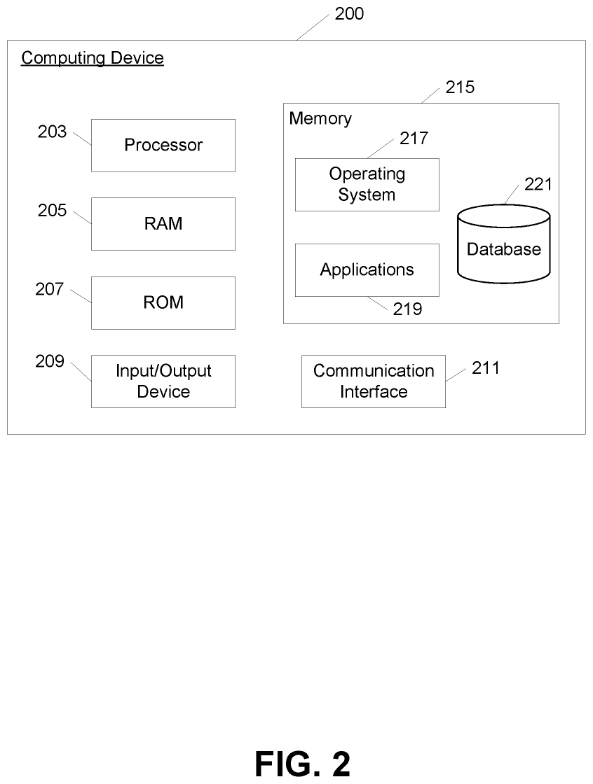

FIG. 1 shows an operating environment 100. The operating environment 100 can include at least one client device 110, at least one interchange analysis server system 120, and/or at least one third-party server system 130 in communication via a network 150. It will be appreciated that the network connections shown are illustrative and any means of establishing a communications link between the computers can be used. The existence of any of various network protocols such as TCP/IP, Ethernet, FTP, HTTP and the like, and of various wireless communication technologies such as GSM, CDMA, WiFi, and LTE, is presumed, and the various computing devices described herein can be configured to communicate using any of these network protocols or technologies. Any of the devices and systems described herein can be implemented, in whole or in part, using one or more computing systems described with respect to FIG. 2.

Client devices 110 can provide queries and/or interact with data as described herein. Interchange analysis server system 120 can generate interchange recommendations for various assets, generate instructions to execute asset interchanges, and/or provide instructions to third-party systems as described herein. Third-party server systems 130 can automatically perform asset interchanges as described herein. However, it should be noted that any computing device in the operating environment 100 can perform any of the processes and/or store any data as described herein. The computing devices can be publicly accessible and/or have restricted access. Access to a particular computing device can be limited based on access requirements for computing devices requesting access to the particular computing device.

Some or all of the data described herein can be stored using one or more databases. Databases can include, but are not limited to relational databases, hierarchical databases, distributed databases, in-memory databases, flat file databases, XML databases, NoSQL databases, graph databases, and/or a combination thereof. Any file system can be used to store data using a database and/or flat file as appropriate. The network 150 can include a local area network (LAN), a wide area network (WAN), a wireless telecommunications network, and/or any other communication network or combination thereof. Processing server systems 130 and/or database server systems can include systems that perform computations on multiple CPUs or GPUs along with serverless environments that mirror recursive function calls. For example, a server system can include a variety of processing nodes, each processing node assigned to execute a single sub-query. The processing nodes can include distinct computing devices and/or virtualized computing devices executing on a single computing device. In this way, the server system can process each sub-query in parallel as described herein.

The data transferred to and from various computing devices in operating environment 100 can include secure and sensitive data, such as confidential documents, customer personally identifiable information, and account data. Therefore, it can be desirable to protect transmissions of such data using secure network protocols and encryption, and/or to protect the integrity of the data when stored on the various computing devices. A file-based integration scheme or a service-based integration scheme can be utilized for transmitting data between the various computing devices. Data can be transmitted using various network communication protocols. Secure data transmission protocols and/or encryption can be used in file transfers to protect the integrity of the data such as, but not limited to, File Transfer Protocol (FTP), Secure File Transfer Protocol (SFTP), and/or Pretty Good Privacy (PGP) encryption. In many embodiments, one or more web services can be implemented within the various computing devices. Web services can be accessed by authorized external devices and users to support input, extraction, and manipulation of data between the various computing devices in the operating environment 100. Web services built to support a personalized display system can be cross-domain and/or cross-platform, and can be built for enterprise use. Data can be transmitted using the Secure Sockets Layer (SSL) or Transport Layer Security (TLS) protocol to provide secure connections between the computing devices. Web services can be implemented using the WS-Security standard, providing for secure SOAP messages using XML encryption. Specialized hardware can be used to provide secure web services. Secure network appliances can include built-in features such as hardware-accelerated SSL and HTTPS, WS-Security, and/or firewalls. Such specialized hardware can be installed and configured in the operating environment 100 in front of one or more computing devices such that any external devices can communicate directly with the specialized hardware.

Turning now to FIG. 2, a conceptual illustration of a computing device 200 that can be used to perform any of the techniques as described herein is shown. The computing device 200 can include a processor 203 for controlling overall operation of the computing device 200 and its associated components, including RAM 205, ROM 207, input/output device 209, communication interface 211, and/or memory 215. A data bus can interconnect processor(s) 203, RAM 205, ROM 207, memory 215, I/O device 209, and/or communication interface 211. In some embodiments, computing device 200 can represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 209 can include a microphone, keypad, touch screen, and/or stylus through which a user of the computing device 200 can provide input, and can also include one or more of a speaker for providing audio output and a video display device for providing textual, audiovisual, and/or graphical output. Software can be stored within memory 215 to provide instructions to processor 203 allowing computing device 200 to perform various actions. Memory 215 can store software used by the computing device 200, such as an operating system 217, application programs 219, and/or one or more databases 221. The various hardware memory units in memory 215 can include volatile and nonvolatile, removable and non-removable media implemented in any method or technology for storage of information such as computer-readable instructions, data structures, program modules, or other data. Memory 215 can include one or more physical persistent memory devices and/or one or more non-persistent memory devices. Memory 215 can include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that can be used to store the desired information and that can be accessed by processor 203.

Communication interface 211 can include one or more transceivers, digital signal processors, and/or additional circuitry and software for communicating via any network, wired or wireless, using any protocol as described herein. It will be appreciated that the network connections shown are illustrative and any means of establishing a communications link between the computers can be used. The existence of any of various network protocols such as TCP/IP, Ethernet, FTP, HTTP and the like, and of various wireless communication technologies such as GSM, CDMA, WiFi, and LTE, is presumed, and the various computing devices described herein can be configured to communicate using any of these network protocols or technologies.

Processor 203 can include one or more central processing units (CPU) and/or graphic processing units (GPU), which can include a single-core or multi-core processor along with multiple processors. Processor(s) 203 and associated components can allow the computing device 200 to execute a series of computer-readable instructions to perform some or all of the processes described herein. Although not shown in FIG. 2, various elements within memory 215 or other components in computing device 200, can include one or more caches including, but not limited to, CPU caches used by the processor 203, page caches used by the operating system 217, disk caches of a hard drive, and/or database caches used to cache content from database 221. For embodiments including a CPU cache, the CPU cache can be used by one or more processors 203 to reduce memory latency and access time. A processor 203 can retrieve data from or write data to the CPU cache rather than reading/writing to memory 215, which can improve the speed of these operations. In some examples, a database cache can be created in which certain data from a database 221 is cached in a separate smaller database in a memory separate from the database, such as in RAM 205 or on a separate computing device. For instance, in a multi-tiered application, a database cache on an application server can reduce data retrieval and data manipulation time by not needing to communicate over a network with a back-end database server. These types of caches and others can be included in various embodiments, and can provide potential advantages in certain implementations of devices, systems, and methods described herein, such as faster response times and less dependence on network conditions when transmitting and receiving data.

Although various components of computing device 200 are described separately, functionality of the various components can be combined and/or performed by a single component and/or multiple computing devices in communication without departing from the invention.

### Generating and Executing Asset Interchanges

As described herein, assets interchanges between groups of users looking to exchange assets can be generated. A graph database can represent users via nodes and edges in the graph database indicating potential interchanges of assets between a user in a first group and a user in a second group. Each of the edges may have an associated weight and interchange recommendations can be determined based on the edges. An interchange recommendation can indicate the first user and the second user and various interchange recommendations can be generated based on the edges in the graph database. The interchange recommendations can be provided to each user and, if both users accept, instructions can be generated to cause the asset interchange to be performed.

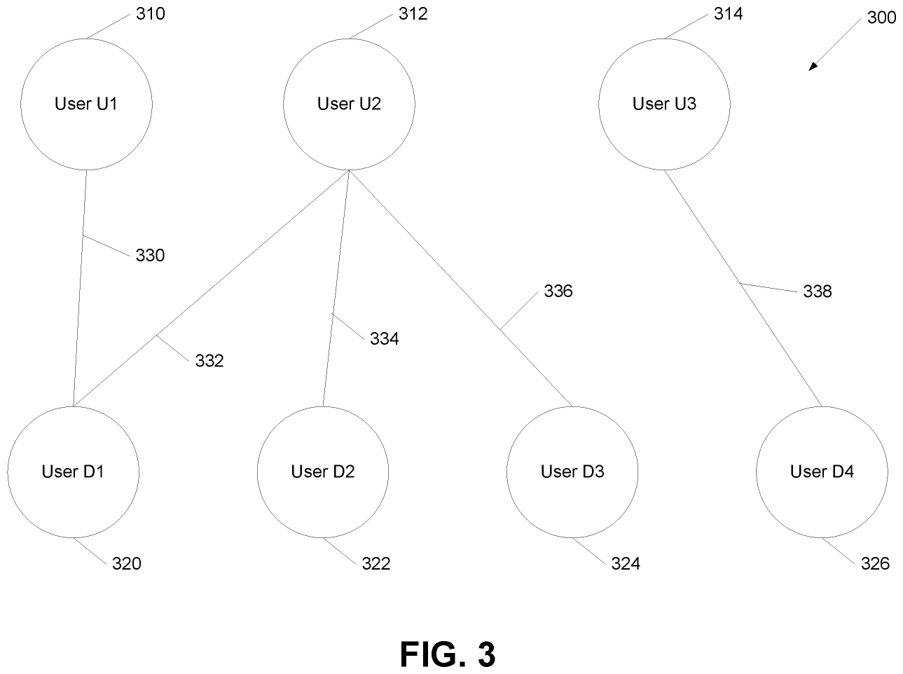

FIG. 3 shows an example graph database according to one or more aspects of the disclosure. Graph database 300 includes a set of upgrade users U1-U3 (nodes 310, 312, and 314) and a set of downgrade users D1-4 (nodes 320, 322, 324, and 326). Graph database 300 further includes edges 330, 332, 334, 336, and 338. Each of these edges represents a potential asset interchange between an upgrade user and a downgrade user—edge 330 indicates an interchange between User U1 and User D1, edge 332 indicates an interchange between User U2 and User D1, edge 334 indicates an interchange between User U2 and User D2, edge 336 indicates an interchange between User U2 and User D3, and edge 338 indicates an interchange between User U3 and User D1.

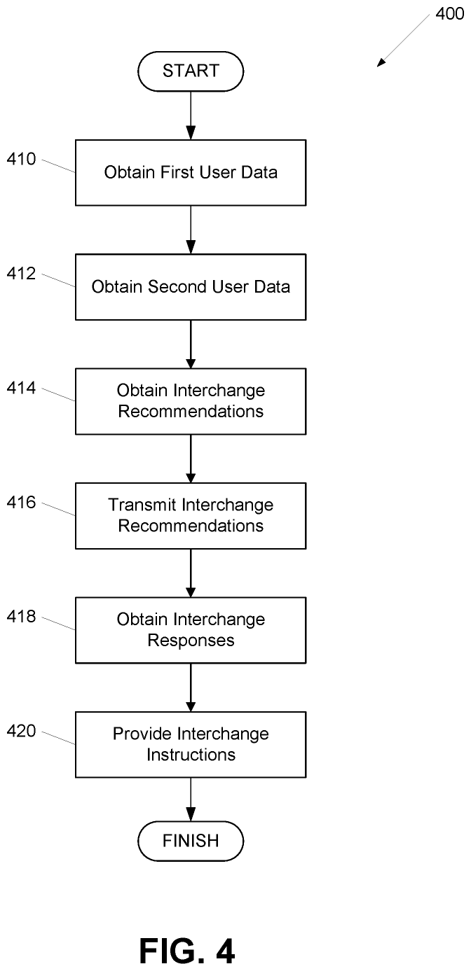

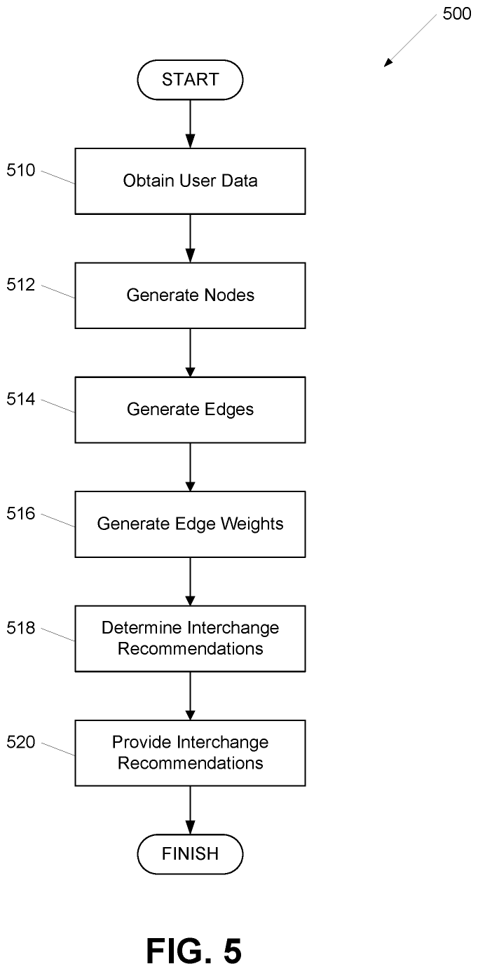

Each edge can be established within the graph database 300 based on one or more assets associated with the users such that the users would potentially enter into an asset interchange if suggested as described herein. As described in more detail with respect to FIGS. 4 and 5, each edge may have a weight indicating the likelihood that the users would perform the potential asset interchange if a recommendation were provided to the users. The graph database 300 can be evaluated to select edges representing interchange recommendations. In many embodiments, a pair of nodes can be selected for only a single asset interchange, and once an interchange recommendation is made for a user the associated nodes and any related edges can be removed from the graph database 300 and/or otherwise ignored for determining other asset interchange recommendations. For example, assume the edges of graph 300 have the following weights:

| Edge | Weight |
|---|---|
| 330 | .8 |
| 332 | 1 |
| 334 | .7 |
| 336 | .4 |
| 338 | .5 |

The edges may be selected in various ways to determine interchange recommendations. For example, the edges can be selected based on the value of the weight, from greatest to least. In this example, edge 332 has the greatest weight and would be selected first. This would remove node 312 and node 320 (as indicated by edge 332) and their associated edges (edges 330, 334, and 336) from further analysis. Therefore, User U1 would not be provided with any asset interchange recommendations as the only potential interchange for User U1 is with User D1. A second interchange recommendation would be selected between User U3 and User D4 based on edge 338.

In a second example, the edges can be selected to maximize the total number of recommendations made, to maximize the likelihood that at least one transaction is made, and/or to maximize the number of nodes within the graph database selected for interchange recommendations. In this example, node 310 and node 314 only have a single potential interchange as represented by edges 330 and 338 respectively.

Therefore, edge 300 and edge 338 can be selected to provide interchange recommendations to User U1 and User D1 and User D3 and User D4, thereby removing these nodes from further consideration. For User U2, edges 334 and 336 remain providing potential interchanges with User D2 and User D3. In this example, edge 334 has the higher likelihood of success and an interchange recommendation can be made between User U2 and User D2 based on edge 334. In this example, three interchange recommendations are made as opposed to the two interchange recommendations made in the previous example.

It should be noted that these weights are provided for example purposes only and that any weight (or no weight at all) can be used as appropriate to the requirements of specific applications of the invention. Additionally, it should be noted that these examples are provided for explanatory purposes only and a variety of graph databases and recommendation selection techniques can be used as needed.

FIG. 4 shows a flow chart of a process for providing interchange instructions according to one or more aspects of the disclosure. Some or all of the steps of process 400 may be performed using one or more computing devices as described herein. In a variety of embodiments, some or all of the steps described below may be combined and/or divided into sub-steps as appropriate.

At step 410, first user data can be obtained. In a variety of embodiments, the first user data can include users that have existing assets that they are looking to upgrade or exchange for newer and/or more valuable assets. The first user data can be obtained directly from the users and/or inferred from user activity as measured by a computing device associated with the user. In a variety of embodiments, the user activity can be described using search queries for a particular class of asset (e.g. vehicles, computers, mobile devices, and/or any other device). The search queries can be obtained to determine a class of assets and/or features of the assets desired by the users by processing the keywords in the search query. For example, a user searching for a new vehicle may provide search queries to an automobile search engine indicating make, model, year, color, trim, budget, and the like for a vehicle that the user wishes to purchase. In a variety of embodiments, the search queries indicate a geographic location and/or geographic area in which the user is searching for an asset (e.g. within 1000 miles of 60607 or Chicago, Ill.) and/or a time at which the search query was provided. In many embodiments, data describing assets associated with the user can also be indicated in the first user data. For example, a user looking for a new vehicle may provide the automobile search engine with information regarding their current car (e.g. make, model, year, VIN, condition, etc.) as part of a trade-in quote. In many embodiments, the features regarding the existing asset(s) can be provided to a third-party system to determine a valuation for the existing assets.

At step 412, second user data can be obtained. In many embodiments, the second user data can include users that have existing assets that they are looking to downgrade or exchange for older and/or less valuable assets. The second user data can be obtained directly from the users and/or inferred from user activity as measured by a computing device associated with the user. In a variety of embodiments, the user activity can be described using search queries for a particular class of asset as described herein. In several embodiments, data describing assets associated with the user can also be indicated in the second user data. For example, a user looking to downgrade their vehicle may provide the automobile search engine with information regarding their current car (e.g. make, model, year, VIN, condition, etc.) as part of a trade-in quote. In many embodiments, the features regarding the existing asset(s) can be provided to a third-party system to determine a valuation for the existing assets.

At step 414, interchange recommendations can be obtained. In a variety of embodiments, interchange recommendations are generated by processing a graph database to identify potential interchange recommendations for various pairings of users described in the first user data and/or second user data. The graph database can include nodes representing the first users and second users and edges indicating a potential asset interchange between a first user and a second user. In many embodiments, the graph database is a bipartite graph between the set of first users described in the first user data and a set of second users described in the second user data. A variety of graph database examples are shown in FIG. 3 and a variety of techniques for generating graph databases are described in more detail with respect to FIG. 5.

The obtained interchange recommendations can be determined based on a calculated weight for each edge in the graph database. The weight can indicate how likely a potential asset interchange is to be successful. For example, the weight for an edge can be determined based on the interest of the first user, the capability of the second user to afford the first user's asset, the ability of the first user's asset to meet the needs of the second user, the location of the assets, transportation costs for transporting the assets from the first user to the second user and vice versa, and the like. A variety of techniques for generating interchange recommendations are described in more detail with respect to FIG. 5.

At step 416, interchange recommendations can be transmitted. The interchange recommendations can be provided to an interchange analysis server system and/or computing device associated with the first user and second user indicated in the interchange recommendation as appropriate. In a variety of embodiments, the interchange recommendation can be included in an email, text message, push notification, or the like that is provided to a computing device (such as a mobile device) associated with the first user and second user and alerting the users to a potential asset interchange. The notification can include one or more features of the interchange and/or a link (such as a URL) to an interchange analysis server system to view details regarding the asset interchange and/or allow the users to accept and/or reject the proposed interchange. In several embodiments, the interchange recommendations can be provided via a pop-up window or web page displayed in a web browser as the user searches for particular assets. In a number of embodiments, the interchange recommendations can be provided by an interchange analysis server system to a computing device associated with the users and solicit the users to visit a web site provided by the interchange analysis server system to view the details of the recommended asset interchange.

At step 418, interchange responses can be obtained. The interchange responses can be obtained via a user input to a website provided by the interchange analysis server system and/or received from a computing device associated with the user(s) indicated in the interchange recommendation. If the interchange response indicates the interchange recommendation has been accepted by both users, instructions can be provided in step 420. If the interchange response indicates that one or both parties have rejected the interchange recommendation, the process can end and/or additional interchange recommendations can be generated for one or both of the users. In a variety of embodiments, the interchange response and the interchange recommendation can be used to (re)train a machine classifier used to generate edge weights as described in more detail herein, particularly with respect to FIG. 5.

At step 420, interchange instructions can be provided. The interchange instructions can be provided to one or more third-party systems and can cause the third-party systems to perform one or more actions to complete the asset interchange. For example, the interchange instructions can cause third-party systems to generate an agreement to be executed by each of the users to transfer ownership of their assets to the other user, to schedule a third-party service to transport the assets from one user to the other, and the like.

FIG. 5 shows a flow chart of a process for generating interchange instructions according to one or more aspects of the disclosure. Some or all of the steps of process 500 may be performed using one or more computing devices as described herein. In a variety of embodiments, some or all of the steps described below may be combined and/or divided into sub-steps as appropriate.

At step 510, user data can be obtained. The user data can indicate one or more users, assets associated with the users, the location of the users and/or assets, assets (and/or features of potential assets) desired by the users, the value of the assets, and the like. In many embodiments, the user data includes user data with respect to a first group of users and a second group of users as described herein with respect to FIG. 4.

At step 512, nodes can be generated. A node can be generated for each user indicated in the user data. In many embodiments, the node indicates the user, assets associated with the user, and/or any other features of the user and/or associated assets included in the user data as described herein.

At step 514, edges can be generated. Each edge can indicate two nodes and represent a potential asset interchange between the users indicated in the nodes. The edges can be generated based on the features of the assets associated with the users, the desired features of new assets for the users, the location of the users and/or assets, the value of the assets, and/or any other feature as described herein.

At step 516, edge weights can be determined. The edge weights can include any number (such as a number between 0 and 1, 0 and 100, −1 and 1, or any other range) or other indicator as appropriate. The edge weights can be determined based on the features of the assets associated with the first user and/or the second user, desired features of new assets for the first user and/or the second user, the location of the assets, a value of the assets, a perceived interest level of one or more of the users, and/or any other feature as appropriate. The perceived interest level of the users can be provided by the users and/or inferred from the user's activities, including the timing and/or number of search queries provided (and/or the search terms provided in the search queries) as described herein. In many embodiments, the edge weights are determined using one or more machine classifiers trained to generate a confidence metric indicating the likelihood that an interchange of the indicated assets would be successful. The machine classifier can generate the confidence metric based on one or more of the indicated features as described herein. In a number of embodiments, the machine classifier is trained based on historical interchange recommendations indicating potential assets (and the features of those assets) and interchange responses (either accept or reject from both users) to those interchange recommendations. It should be readily apparent to one having ordinary skill in the art that a variety of machine classifiers can be utilized including (but not limited to) decision trees, k-nearest neighbors, support vector machines (SVM), neural networks (NN), recurrent neural networks (RNN), convolutional neural networks (CNN), and/or probabilistic neural networks (PNN). RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In a number of embodiments, a combination of machine classifiers can be utilized, more specific machine classifiers when available, and general machine classifiers at other times can further increase the accuracy of the generated confidence metrics.

In a number of embodiments, edges can be generated (514) between every pair of nodes generated (512) within the graph database. Edge weights can be generated (516) for each of the edges and the edge weight for invalid (and/or undesired) asset interchanges can be set to a particular value, such as zero or a negative number. Once calculated, edges with a weight at or below the particular value can be ignored and/or deleted from the graph database. In this way, the generation of the edge weights can be used to generate the edges in a variety of embodiments of the invention.

At step 518, interchange recommendations can be determined. The interchange recommendations can be determined based on the generated edge weights. In a variety of embodiments, the interchange recommendations can be determined based on selecting the edges with the highest weights and/or selecting the edges to maximize the number of nodes within the graph database selected as described herein, particularly with respect to FIG. 3. The determined interchange recommendations can indicate a pair of users associated with the recommendation, the assets associated with the users, the location of the users, the location of the assets, and/or any other feature of the users and/or assets as described herein. In many embodiments, the interchange recommendation includes the confidence metric associated with the edge corresponding to the interchange recommendation.

At step 520, interchange recommendations can be provided. The interchange recommendations can be provided to a computing device requesting the interchange recommendations and/or to computing devices associated with the users indicated in the interchange recommendation as described herein.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied, in whole or in part, in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method comprising:
receiving an indication that a user wants to exchange a first product owned by the user;
determining, based on one or more properties of the first product, a plurality of second products different from the first product;
identifying a plurality of second users that own at least one of the plurality of second products;
generating a bipartite graph representing a plurality of different connections between the user and the plurality of second users, wherein each connection of the plurality of different connections represents an interchange of the first product with one or more of the plurality of second products;
generating an interchange recommendation from the bipartite graph and based on the plurality of different connections;
transmitting the interchange recommendation to a first computing device associated with the user and a second computing device associated with a second user associated with the second product of the plurality of second products identified in the interchange recommendation;
receiving an interchange approval message from the first computing device and the second computing device;
generating interchange instructions indicating the interchange recommendation; and
transmitting the generated interchange instructions.

2. The computer-implemented method of claim 1, wherein generating the interchange recommendation comprises:
providing, as input to a trained machine learning model, data corresponding to the bipartite graph, wherein the trained machine learning model has been trained based on a history of product interchanges;
receiving, as output from the trained machine learning model, an indication of a selected connection; and
generating the interchange recommendation based on the selected connection.

3. The computer-implemented method of claim 1, wherein generating the interchange recommendation comprises:
calculating, for each of the plurality of different connections, a confidence metric determined based on criteria selected from the group consisting of a geographical location of the user, a value of the first product, and a perceived interest of the user; and
selecting a connection in the plurality of different connections as the interchange recommendation based on the confidence metric.

4. The computer-implemented method of claim 3, wherein the selected connection comprises the connection with the highest confidence metric.

5. The computer-implemented method of claim 3, wherein the selected connection comprises the connection that, when selected, maximizes a value of the remaining connections within the bipartite graph.

6. The computer-implemented method of claim 3, wherein the selected connection comprises a connection having a confidence metric exceeding a threshold value.

7. The computer-implemented method of claim 1, further comprising removing the user and the second user indicated in the interchange recommendation from the bipartite graph.

8. The computer-implemented method of claim 1, wherein the indication that the user wants to exchange the first product comprises a search query for at least one of the plurality of second products.

9. The computer-implemented method of claim 1, wherein determining the plurality of second products comprises:
determining an age of the first product; and
querying a product database for products newer than the first product.

10. The computer-implemented method of claim 1, wherein the interchange instructions cause a third-party system to execute the interchange of the first product and the second product.

11. The computer-implemented method of claim 10, wherein the interchange instructions further cause the third-party system to:
obtain first location information for the user;
obtain second location information for the second user associated with the second product identified in the interchange recommendation;
calculate a distance between the first location information and the second location information; and
provide an indication of the calculated distance to the user and the second user.

12. An apparatus comprising:
one or more processors; and
memory storing instructions that, when executed by the one or more processors, cause the apparatus to:
receive an indication that a user wants to exchange a first product owned by the user;
determine, based on one or more properties of the first product, a plurality of second products different from the first product;
identify a plurality of second users that own at least one of the plurality of second products;
generating a bipartite graph representing a plurality of different connections between the user and the plurality of second users, wherein each connection of the plurality of different connections represents an interchange of the first product with one or more of the plurality of second products;
generate an interchange recommendation from the bipartite graph and based on the plurality of different connections;
transmit the interchange recommendation to a first computing device associated with the user and a second computing device associated with a second user associated with the second product of the plurality of second products identified in the interchange recommendation;
receive an interchange approval message from the first computing device and the second computing device;
generate interchange instructions indicating the interchange recommendation; and
transmit the generated interchange instructions.

13. The apparatus of claim 12, wherein the interchange recommendation is generated by:
providing, as input to a trained machine learning model, data corresponding to the bipartite graph, wherein the trained machine learning model has been trained based on a history of product interchanges;
receiving, as output from the trained machine learning model, an indication of a selected connection; and
generating the interchange recommendation based on the selected connection.

14. The apparatus of claim 12, wherein the interchange recommendation is generated by:
calculating, for each of the plurality of different connections, a confidence metric determined based on criteria selected from the group consisting of a geographical location of the user, a value of the first product, and a perceived interest of the user; and
selecting a connection in the plurality of different connections as the interchange recommendation based on the confidence metric.

15. The apparatus of claim 14, wherein the selected connection is determined based on criteria selected from the group consisting of the connection with the highest confidence metric, the connection that, when selected, maximizes a value of the remaining connections within the bipartite graph, and a connection having a confidence metric exceeding a threshold value.

16. The apparatus of claim 12, wherein the indication that the user wants to exchange the first product comprises a search query for at least one of the plurality of second products.

17. The apparatus of claim 12, wherein the interchange instructions cause a third-party system to execute the interchange of the first product and the second product.

18. One or more non-transitory computer-readable media storing instructions that, when executed by one or more processors, cause a computing device to:
receive an indication that a user wants to exchange a first product owned by the user;
determine, based on one or more properties of the first product, a plurality of second products different from the first product;
identify a plurality of second users that own at least one of the plurality of second products;
generating a bipartite graph representing a plurality of different connections between the user and the plurality of second users, wherein each connection of the plurality of different connections represents an interchange of the first product with one or more of the plurality of second products;
generate an interchange recommendation from the bipartite graph and based on the plurality of different connections;
transmit the interchange recommendation to a first computing device associated with the user and a second computing device associated with a second user associated with the second product of the plurality of second products identified in the interchange recommendation;
receive an interchange approval message from the first computing device and the second computing device;
generate interchange instructions indicating the interchange recommendation; and
transmit the generated interchange instructions.

19. The computer-readable media of claim 18, wherein the instructions, when executed by the one or more processors, cause the computing device to:
calculate, for each of the plurality of different connections, a confidence metric determined based on criteria selected from the group consisting of a geographical location of the user, a value of the first product, and a perceived interest of the user; and
select a connection in the plurality of different connections as the interchange recommendation based on the confidence metric.

20. The computer-readable media of claim 18, wherein the interchange instructions cause a third-party system to execute the interchange of the first product and the second product.
